(19) United States
(12) Patent Application Publication
(10) Pub. No.: US 2009/0015977 A1
(43) Pub. Date: Jan. 15, 2009

(54) Line Protection Load Switch For Portable Device

(75) Inventor: Hardik Dineshchandra Patel, San Jose, CA (US)

Correspondence Address: BEVER HOFFMAN & HARMS, LLP;2099 Gateway Place, Suite 320, San Jose, CA, 95110, US

(73) Assignee: Micrel, Incorporated, San Jose, CA (US)

(21) Appl. No.: 11/777,260

(22) Filed: Jul. 12, 2007

(51) Int. Cl. H02H 3/24

(52) U.S. Cl. 361/92

(57) ABSTRACT

A portable device includes a voltage regulator for generating a regulated voltage that is supplied to a processor and to a load by way of a line protection switch, which controls a load current supplied to the load, e.g., in response to a signal supplied by the processor. The line protection switch includes a gate control circuit with a comparator that detects a short circuit in the load by comparing the regulated voltage against a reference voltage. When a short circuit causes the regulated voltage to drop below a predetermined minimum voltage (e.g., 4.5V), the comparator de-asserts the control signal, thereby turning off the switch before the regulated output voltage falls below a minimum operating voltage (e.g., 4.35V) of the processor.

### FIELD OF THE INVENTION

This invention relates to portable devices or systems that utilize load switches and, in particular, to load switches and current limiting power distribution switches for such portable devices/systems.

### BACKGROUND OF THE INVENTION

FIG. 3 shows a portable device (system) 10, such as a laptop computer or cell phone, that utilizes a DC-DC buck regulator 11 to convert an unregulated voltage V_{UN-REG} generated by a battery B to provide a regulated (e.g., 5V) voltage V_{REG} to a processor 12 and also to a load 15 (e.g., an LED display or disk drive or power amplifier (not shown) of portable device 10). Switching regulators and linear regulators are well known types of voltage regulators for converting an unregulated voltage, such as battery voltage V_{UN-REG}, to a regulated DC output voltage of a desired value. A load switch 13 is connected between the 5V output terminal of buck regulator 11 and load 15. Load switches, which are also known in the art, serve to control the flow of power between a source and a load. In the present example, load switch 13, when enabled, transmits power from DC-DC buck regulator 11 to load 15. Load switch 13, when disabled, prevents power from reaching load 15.

A problem with the conventional arrangement shown in FIG. 3 arises, for example, when load switch 13 is enabled and the load 15 becomes short circuited (e.g., as shown in FIG. 4). This short circuit situation typically results in a significant (short circuit) current being drawn by load 15 through load switch 13 from DC-DC buck regulator 11. If DC-DC buck regulator 11 is not able to provide the short circuit current, then the output voltage of buck regulator 11 supplied to processor 12 and load 15 will drop below 5V. If the output voltage drops below the minimum operating voltage of processor 12 (e.g., below 4.35V), then processor 12 will shut down, causing system failure and the potential loss of critical data.

What is needed is a system/method for ensuring that if load 15 becomes short circuited, load switch 13 will shut off before the output voltage of buck regulator 11 drops below a predetermined minimum voltage (e.g., 4.35V), thus ensuring that the processor will not shut down.

### SUMMARY OF THE INVENTION

The present invention is directed to system in which both a processor and a line protection (load) switch are connected to a power source (e.g., a battery and a DC-DC buck regulator or other voltage regulator), wherein the line protection switch includes means for detecting a short circuit condition in an attached load, and for immediately cutting off power to the attached load when the short circuit condition is detected, thereby preventing the source voltage applied to the processor from dropping below its minimum operating voltage, thus preventing system failure and the potential loss of critical data due to unintended shut-down of the processor.

In accordance with an embodiment of the present invention, the line protection switch for controlling the load current includes a switch circuit (e.g., a p-channel MOSFET) that is connected between the power source input terminal and the load/output terminal, and a gate control circuit for controlling the switch circuit (i.e., turning on/off the switch or rate at which the switch turns on) by asserting the control signal only while the source voltage is greater than the minimum voltage level. In one embodiment the gate control circuit includes a comparator having a non-inverting input terminal coupled to the source voltage by way of a voltage divider, and an inverting terminal connected to receive the reference voltage, which is generated by a reference circuit. The comparator asserts a first intermediate control signal when the source voltage is above the predetermined minimum voltage defined by the reference voltage, and de-asserts the first intermediate control signal when the source voltage drops below the predetermined minimum voltage, which is indicative of a short circuit condition in the load. The first intermediate control signal generated by the comparator is supplied to a logic circuit that enables (asserts) the second intermediate control signal when both the signal from the comparator and Enable input signal generated by the processor are asserted. In one embodiment the second intermediate control signal is shaped by a level shift and slew rate control circuit to generate the final control signal that is applied to the gate terminal of the switch circuit.

In accordance with another embodiment of the present invention, a portable device (e.g., a laptop computer, cell phone) includes a regulated voltage source (e.g., a battery connected to a DC-DC buck regulator) that supplies a regulated 5V source voltage to a processor, and to a load by way of the line protection switch of the present invention.

### BRIEF DESCRIPTION OF THE DRAWINGS

These and other features, aspects and advantages of the present invention will become better understood with regard to the following description, appended claims, and accompanying drawings, where:

FIG. 1 is a block diagram showing a portable device/system including a line protection (load) switch configured in accordance with the present invention;

FIG. 2 is a simplified circuit diagram showing a line protection switch in accordance with an exemplary specific embodiment of the present invention;

FIG. 3 is a block diagram showing a system utilizing a load switch in accordance with conventional practices; and

FIG. 4 is a block diagram showing the system of FIG. 3 when the load experiences a short circuit condition.

### DETAILED DESCRIPTION OF THE DRAWINGS

The present invention relates to an improvement in line protection switches. The following description is presented to enable one of ordinary skill in the art to make and use the invention as provided in the context of a particular application and its requirements. The terms “coupled” and “connected”, which are utilized herein, are defined as follows. The term “connected” is used to describe a direct connection between two circuit elements, for example, by way of a metal line formed in accordance with normal integrated circuit fabrication techniques. In contrast, the term “coupled” is used to describe either a direct connection or an indirect connection between two circuit elements. For example, two coupled elements may be directly connected by way of a metal line, or indirectly connected by way of an intervening circuit element (e.g., a capacitor, resistor, inductor, or by way of the source/drain terminals of a transistor). Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

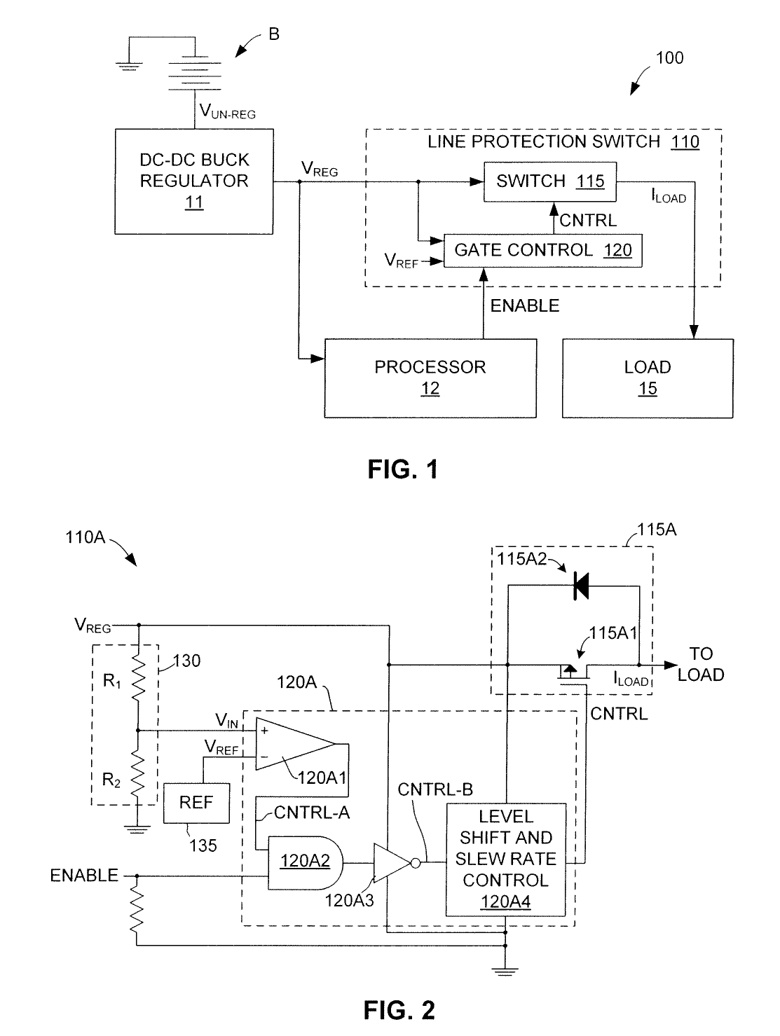

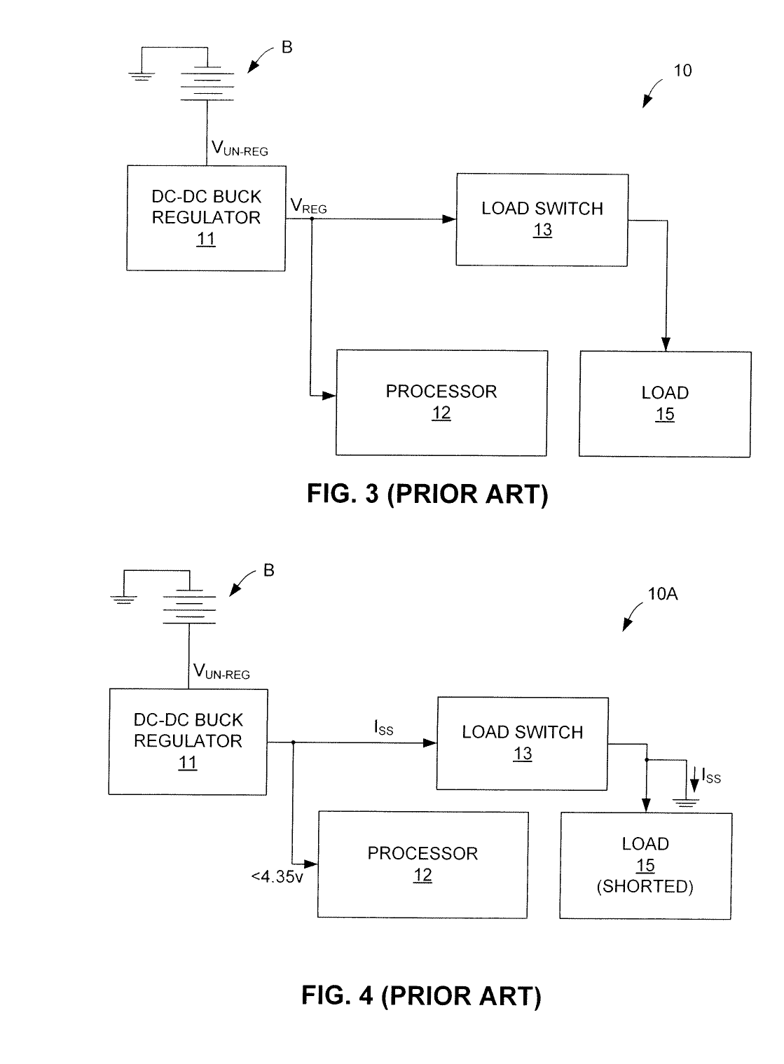

FIG. 1 shows a portable device (system) 100, such as a laptop computer or cell phone that includes a regulated voltage source (e.g., a DC-DC buck (voltage) regulator 11 that converts an unregulated voltage V_{UN-REG} generated by a battery B to provide a regulated 5V output voltage V_{REG}), a processor 12 and a load 15 (e.g., an LED display or disk drive or power amplifier) that is connected to the voltage source by way of a line protection switch 110. DC-DC buck-type voltage regulators are well known types of voltage regulators for converting an unregulated voltage, such as a battery voltage, to a regulated DC output voltage of a desired value. Processor 12 represents any of a number of different known types of microprocessors utilized in portable devices.

In accordance with the present invention, line protection switch 110 includes a switch circuit 115 and a gate control circuit 120 that serves to detect a short circuit condition in load 15, and to shut down switch 115 (i.e., terminate load current I_{LOAD}) before regulated voltage V_{REG} falls below a minimum operating voltage associated with processor 12 (e.g., 4.35V). Similar to conventional load switches 13, during normal operating conditions (i.e., when the load current I_{LOAD} is maintained such that regulated voltage V_{REG} is 5V), line protection switch 110 serves to supply load current I_{LOAD} to load 15 while a switch enable signal ENABLE, which is received from processor 12, is asserted. However, unlike conventional load switches, line protection switch 110 detects the short circuit condition by monitoring the load current I_{LOAD} passing through line protection switch 110 to load 15, and determining when regulated voltage V_{REG} falls below a predetermined minimum voltage (e.g., 4.5V), which occurs when load 15 experiences a short circuit. In the present embodiment, this detection process involves comparing the regulated voltage V_{REG} with a reference voltage V_{REF}, which is generated in a way that causes gate control circuit 120 to assert control signal CNTRL when regulated voltage V_{REG} is above the predetermined minimum voltage. Turning off load current I_{LOAD}, which occurs when regulated voltage V_{REG} drops to the predetermined minimum voltage, involves de-asserting control signal CNTRL, which turns off switch circuit 115 to create an open circuit between regulator 11 and load 15, thus terminating the load current and allowing DC-DC buck regulator 11 to maintain regulated voltage V_{REG} above the minimum operating voltage of processor 12. Preferably, the response time between the drop in regulated voltage V_{REG} level due to the short circuit condition and turning off switch 110 will be short enough to prevent regulated voltage V_{REG} level from dropping below the minimum operating voltage (4.35V) of processor 11, thereby avoiding the unintentional shut-down of the processor 11. The response time to shut off the switch can be made small, for example, by providing a fast comparator 120A1 and fast logic gates 120A2, which are described with reference to the provided specific embodiment.

FIG. 2 is a simplified circuit diagram showing a line protection switch 110A according to a specific embodiment of the present invention. Line protection switch 110A includes switch circuit 115A, gate control circuit 120A, a voltage divider 130, and a reference circuit 135.

Switch circuit 115A includes a p-channel MOSFET 115A1 that is connected between the input terminal (i.e., regulated voltage V_{REG} ) and the output terminal (i.e., load 15; see FIG. 1). The body diode between drain and body of the p-channel MOSFET is depicted as diode 115A2. The source of MOSFET 115A1 is connected to the body of MOSFET 115A1. Diode 115A2 may or may not be present.

Gate control circuit 120A includes a comparator 120A1 having a non-inverting input terminal coupled to the regulated (source) voltage V_{REG} by way of voltage divider 130, and an inverting terminal connected to receive the reference voltage V_{REF} generated by a reference circuit 135. Voltage divider, which includes resistors R1 and R2 that are selected to produce a desired input voltage V_{IN}, which represents a predetermined portion of regulated voltage V_{REG} using known techniques, my either be internal or external to line protection switch 110A. Input voltage V_{IN} and reference voltage V_{REF} are selected such that the comparator 120A1 asserts a first intermediate control signal CNTRL-A (e.g., generates a 5V output) when regulated voltage V_{REG} is above the predetermined minimum voltage (e.g., 4.5V), and de-asserts first intermediate control signal CNTRL-A (e.g., generates a 0V output) when regulated voltage V_{REG} is at or below the predetermined minimum voltage. In one embodiment, first intermediate control signal CNTRL-A may be directly supplied to the gate terminal of MOSFET 115A1.

In accordance with an embodiment of the present invention, gate control circuit 120A also includes a logic circuit made up of an AND gate 120A2 and an inverting buffer 120A3 that serve to enable a second intermediate control signal CNTRL-B only when regulated voltage V_{REG} is greater than the minimum voltage level (i.e., first intermediate control signal CNTRL-A is asserted), and when the enable signal ENABLE received from processor 12 is also asserted. Specifically, AND gate 120A2 has a first input terminal connected to an output terminal of the comparator 120A1, and a second input terminal connected to receive enable signal ENABLE from the processor 12 (shown in FIG. 1). An output terminal of AND gate 120A2 is passed through inverter 120A3 to provide second intermediate control signal CNTRL-B. Thus, when both ENABLE is asserted and V_{REG} is greater than the minimum voltage level (i.e., first intermediate control signal CNTRL-A is asserted), the high output signal generated by AND gate 120A2 is inverted to assert a low second intermediate control signal CNTRL-B. Conversely, when ENABLE is asserted but a short condition occurs in load 15 (or if ENABLE is de-asserted), the low output signal from AND gate 120A2 is inverted to de-assert a high second control signal CNTRL-B.

In accordance with another aspect of the present invention, gate control circuit 120A also includes a level shift and slew rate control circuit 120A4 that controls the turn on time of the switch. This is currently present in the normal load switches.

Although the present invention has been described with respect to certain specific embodiments, it will be clear to those skilled in the art that the inventive features of the present invention are applicable to other embodiments as well, all of which are intended to fall within the scope of the present invention.

1. A line protection switch for controlling a load current supplied to a load in a system including a power source that provides a source voltage for operating both a processor and the load, wherein the line protection switch comprises:
a switch circuit having an input terminal for receiving the source voltage generated, an output terminal, and a power transistor for selectively passing the load current from the input terminal to the output terminal; and
means for detecting a short circuit condition in the load, and for controlling the switch to terminate the load current when the short circuit condition is detected.

2. The line protection switch according to claim 1, wherein said means comprises a gate control circuit having a first input terminal for receiving the source voltage, a second input terminal for receiving a reference voltage, and means for asserting a control signal only while the source voltage is greater than a minimum voltage level determined by the reference voltage.

3. The line protection switch according to claim 2, wherein the gate control circuit comprises a comparator having a non-inverting input terminal coupled to the source voltage and an inverting terminal connected to receive the reference voltage.

4. The line protection switch according to claim 3, further comprising a voltage divider connected to the non-inverting input terminal of the comparator such that a predetermined portion of the source voltage is supplied to the non-inverting input terminal of the comparator.

5. The line protection switch according to claim 3, wherein the gate control circuit further comprises a logic circuit having a first input terminal connected to an output terminal of the comparator, and a second input terminal for receiving a switch enable signal from the processor, and means for enabling the control signal only when the source voltage is greater than the minimum voltage level and the enable signal is asserted.

6. The line protection switch according to claim 5, wherein the gate control circuit further comprises a level shift and slew control circuit connected between an output terminal logic gate and the switch circuit.

7. The line protection switch according to claim 6, wherein the switch circuit comprises a p-channel MOSFET having a gate terminal connected to an output terminal of the level shift and slew rate control circuit.

8. A portable device comprising:
a voltage source for generating a regulated voltage;
a processor connected to receive the regulated voltage from the voltage source;
a load; and
a line protection switch connected between the voltage regulator and the load for controlling a load current supplied to the load, wherein the line protection switch comprises:
a switch circuit having an input terminal connected to the voltage regulator, an output terminal connected to the load, and a power transistor for selectively passing a load current from the input terminal to the output terminal; and
means for detecting a short circuit condition in the load, and for controlling the switch to terminate the load current when the short circuit condition is detected.

9. The portable device according to claim 8, wherein the voltage source comprises a battery for generating an unregulated voltage signal, and a voltage regulator for converting the unregulated voltage signal into said regulated voltage.

10. The portable device according to claim 8, wherein said means comprises a gate control circuit having a first input terminal for receiving the regulated voltage, a second input terminal for receiving a reference voltage, and means for asserting a control signal only while the regulated voltage is greater than the reference voltage.

11. The portable device according to claim 10, wherein the gate control circuit comprises a comparator having a non-inverting input terminal coupled to the voltage source and an inverting terminal connected to receive the reference voltage.

12. The portable device according to claim 11, further comprising a voltage divider for applying a predetermined portion of the regulated voltage to the non-inverting input terminal of the comparator.

13. The portable device according to claim 12, wherein the gate control circuit further comprises a logic circuit having a first input terminal connected to an output terminal of the comparator, a second input terminal for receiving an enable signal from the processor, and means for enabling the control signal only when the regulated voltage is greater than the minimum voltage level and the enable signal is asserted.

14. The portable device according to claim 13, wherein the gate control circuit further comprises a level shift and slew rate control circuit connected between an output terminal logic gate and the switch circuit.

15. The portable device according to claim 14,
wherein the switch circuit comprises a p-channel MOSFET, and
wherein a gate terminal of the p-channel MOSFET is connected to an output terminal of the level shift and slew rate control circuit.

16. The portable device according to claim 8, wherein the portable device comprises one of a laptop computer and a cell phone.
